(19) United States
(12) Patent Application Publication
(10) Pub. No.: US 2015/0360445 A1
(43) Pub. Date: Dec. 17, 2015

(54) WOOD AND FIBERGLASS HYBRID GLASS DOOR

(71) Applicant: MaxCraft Doors, Inc., Suwanee, GA (US)

(72) Inventor: Zhihua Cai, Suwanee, GA (US)

(21) Appl. No.: 14/305,126

(22) Filed: Jun. 16, 2014

(51) Int. Cl. B32B 17/06; B32B 3/08; B32B 3/30; E06B 3/70

(52) U.S. Cl. CPC B32B 17/062; E06B 3/70; B32B 3/08; B32B 3/30; B32B 2250/05; B32B 2262/101; B32B 2307/712; B32B 2419/00

(57) ABSTRACT

A hybrid fiberglass wood door has a first fiberglass skin; a second fiberglass skin, and an internal wood block disposed therebetween. A wood veneer is attached to an outer surface of the second fiberglass skin. A first glass stop is connected to the first fiberglass skin and a second glass stop is connected to the internal wood block. A glass pane is secured between the first and the second glass stops.

### BACKGROUND OF THE INVENTION

This invention is directed to a hybrid glass door and more particularly to a hybrid door combining features of a wood door and a fiberglass door.

Wood and fiberglass doors are widely used as patio doors. Wood doors are popular because of their natural beauty, but they are not energy efficient and will warp, swell and rot over time. In addition, wood doors require costly and time consuming maintenance over the life of the door that includes scraping, sanding and refinishing otherwise the life of the door and its aesthetic appeal may be diminished. Fiberglass doors are very durable and energy efficient, and they do not require much of the maintenance required by wood doors. However, fiberglass doors lack the warmth, beauty and aesthetic appeal of natural wood doors. Desired is a door that combines the aesthetic beauty of a wood door and the durability and longevity of a fiberglass door.

Therefore, an objective of the invention is to provide a wood and fiberglass hybrid glass door having a wood veneer.

Another objective of the invention is to provide a wood and fiberglass hybrid glass door with the appearance of a wood door.

Yet another objective of the invention is to provide a wood and fiberglass hybrid glass door that has a long useful life.

Another objective of the invention is to provide a wood and fiberglass hybrid glass door that is inexpensive.

Yet another objective of the invention is to provide a wood and fiberglass hybrid glass door that is durable.

Another objective of the invention is to provide a wood and fiberglass hybrid glass door that does not require the maintenance of a conventional wood door.

Yet another objective of the invention is to provide a wood and fiberglass hybrid glass door that is more efficient than a conventional wood door.

These and other objectives will be apparent to one of ordinary skill in the art based upon the following written description, drawings and claims.

### SUMMARY OF THE INVENTION

A hybrid fiberglass and wood door has a first fiberglass skin; a second fiberglass skin, and an internal wood block disposed therebetween. A wood veneer is attached to an outer surface of the second fiberglass skin. A first glass stop is connected to the first fiberglass skin and a second glass stop is connected to the internal wood block. A glass pane is secured between the first and the second glass stops.

### BRIEF DESCRIPTION OF THE DRAWINGS

FIG. 1 is a rear view of a hybrid fiberglass and wood door;

FIG. 2 is a side sectional view of a first embodiment of a hybrid fiberglass and wood door;

FIG. 3 is a side sectional view of a second embodiment of a hybrid fiberglass and wood door; and

FIG. 4 is a side sectional view of a third embodiment of a hybrid fiberglass and wood door.

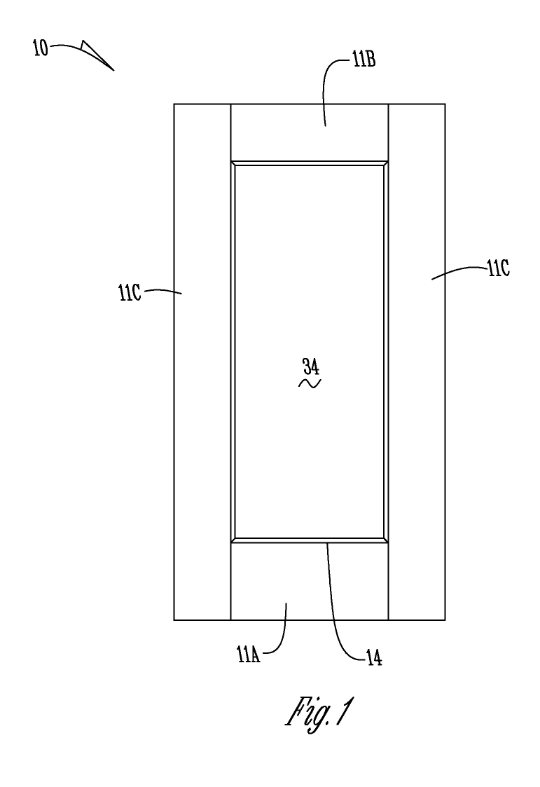

### DETAILED DESCRIPTION OF THE PREFERRED EMBODIMENTS

Referring to the Figures, a wood fiberglass hybrid glass door 10 is formed of a plurality of sections 11, such as a lower section 11a, an opposite upper section 11b, and opposing side sections 11c. Sections 11 include a first fiberglass skin 12 that terminates in an outwardly extending glass stop 14 that preferably is formed integral to the first skin 12 as a single piece, however it is also contemplated that the first skin and glass stop 14 can be separate pieces. In the arrangement shown, glass stop 14 takes the form of a piece of trim, such as quarter round or the like. A second fiberglass skin 16 is positioned in parallel spaced relation to the first skin 12 and is positioned on the opposite side of door 10.

Disposed between the first skin 12 and the second skin 16 are stiles or rails 18, polyurethane foam 20, an external wood block 22, and an internal wood block 24. The stiles or rails 18 preferably are made of wood or composite, or any other material such as metal, plastic or the like. In one arrangement styles or rails 18 have a groove 25 that receives a protuberance 26 on the external wood block 22 which serves to hold rails 18 together with external wood block 22. In an alternative arrangement, no such groove 25 and corresponding protuberance 26 is present on rails 18 and external wood block 22. Instead, the facing surfaces of rails 18 and external wood block 22 are flat and positioned in flush alignment with one another and these two components are connected to one another by any other means such as through the use of fasteners (such as screws, bolts, or the like), through the use of gluing, welding or adhesives, through the use of snap fit features or frictional engagement, or by any other connection methods or means. The foam 20 is disposed between the rail 18 and the internal wood block 24 and fills the space therebetween the interior surfaces of first skin 12, second skin 16, rail 18 and internal wood block 24.

The internal wood block 24 can be cut for different applications. In one embodiment, as shown in FIG. 2, internal wood block 24 has a notch 27 that receives the second skin 16. In this arrangement, notch 27 is approximately as deep as the internal skin 16 is thick. As such, the external surface of notch 27 receives or engages the internal surface of second skin 16 in flush abutting alignment and engagement. In this arrangement, internal wood block 24 has a flange portion 27a that extends past the step of notch 27. The outward most edge, or the edge opposite first skin 12 of flange 27a terminates in line, or terminates in plane with the outward most edge of second skin 16. That is, the outer surface of the second skin 16 and the outer edge of flange 27a of internal wood block 24 dwell in the same plane. In this arrangement a portion of flange portion 27, opposite second skin 16 has a reveal section, meaning it is exposed and visible. This also means, that the flange portion 27 fully covers the end of second skin 16 and prevents it from being visible.

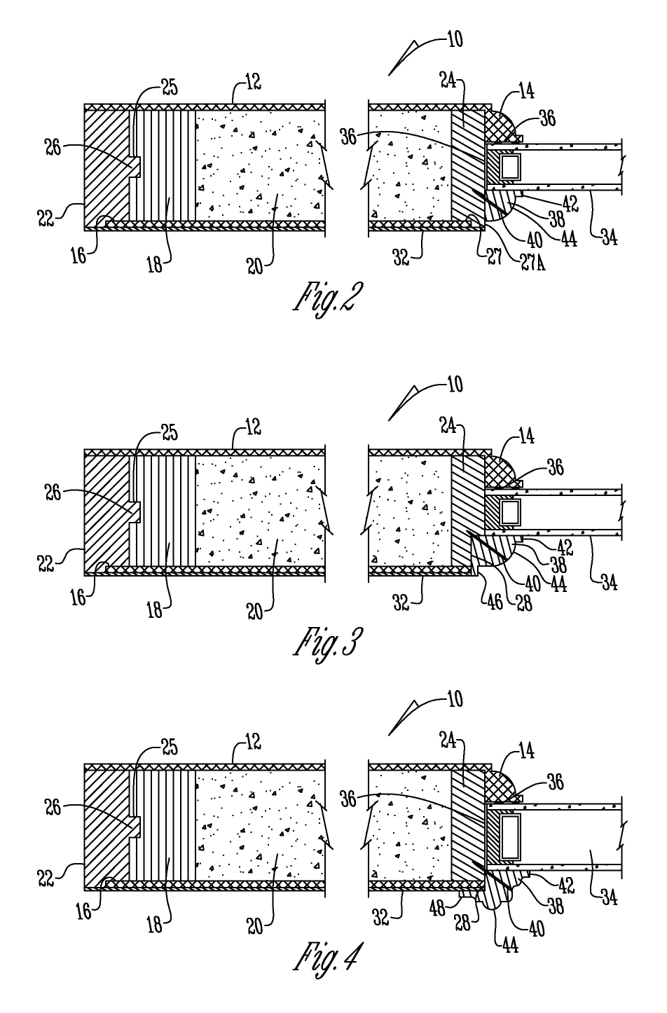

In a second embodiment, as shown in FIG. 3, a notch 28 is cut from an outer corner of internal block 24. That is, notch 28 is cut out of the corner of internal wood block 24 which is opposite external wood block 22 and opposite first skin 12. In this arrangement, the external surface of internal wood block 24 engages or abuts in flush alignment with the internal surface of second skin 16. In addition notch 28 is cut to a depth wherein the end of second skin 16 is aligned with notch 28, or said another way, the end of second skin 16 is in plane or aligned with the surface of internal wood block 24 which forms notch 28. In this way, when the internal wood block 24 and second skin 16 are connected to one another, the surface of notch 28 and the end of second skin 16 are in fiat and flush alignment with one another.

In a third embodiment, as shown in FIG. 4, the internal wood block 24 does not have a notch and is generally rectangular such that the internal surface of second skin 16 is in flat and flush engagement and abutment with the external surface of internal wood block 24 which is opposite first skin 12. Also in this arrangement, the end of the second skin 16 opposite external wood block 22 aliens with the outer surface of the internal block 24 which is also opposite external wood block 22. In this way, when the internal wood block 24 and second skin 16 are connected to one another, the end of second skin 16 the surface of internal wood block 24 are in flat and flush alignment with one another.

Attached to the outer surface of the second skin 16 is a wood veneer 32. Preferably, the wood veneer 32 is attached to the second skin 16 by first lightly sanding the outer surface of the second skin 16. Next, a water resistant adhesive is applied to an internal side of the wood veneer. Optionally a water resistant adhesive is also applied to the external side of the second skin 16. Finally, the wood veneer 32 is bonded to the outer surface of the second skin 16 using a cold or hot vacuum press (not shown).

To secure a pane of glass 34 within a window opening, caulk 36 is applied to the internal edge of glass stop 14. Optionally, calk is also applied to the surface of internal wood block 24 adjacent glass stop 14. Next, the pane of glass 34 is placed against stop 14 and internal wood block 24, in engagement with calk 36, such that calk 36 seals the pane of glass 34 to the glass stop 14, and/or internal wood block 24. A second glass stop 38, made of wood, is placed against the pane of glass 34 on the side opposite the first glass stop 14. Optionally, calk 36 is also positioned between second glass stop 38 and pane of glass 34 to seal and adhere the two components together. The second stop 38 is connected to the internal wood block 24 by using a brad nail 40 that extends through second glass stop 38 and into internal wood block 24, or any other mechanical means such as a screw, bolt, snap fit feature, or by adhering the two components using adhesive, glue, composite or any other or chemical means.

The second glass stop 38 is formed of any suitable size, shape and design and can be formed of different sizes and shapes for different applications and desired aesthetic appearances. In one embodiment, as shown in FIG. 2, the second glass stop 38 has a square corner which is opposite a rounded surface 44. A first squared flange 42 protrudes from second glass stop in parallel spaced relation to pane of glass 34. In this arrangement, one side of the square corner engages the pane of glass 34 and a second side engages wood block 24. In this arrangement, the edge of rounded surface 44 opposite first squared flange 42 terminates at the external surface of internal wood block 24 before its outward most edge. This provides a certain amount of reveal or exposed surface of internal wood block 24 and the end of wood veneer 32 adjacent the flange portion 27a which provides a unique and appealing aesthetic appearance.

Alternatively, as shown in FIG. 3, the second glass stop 38 includes a square corner which is opposite a rounded surface 44, and further includes a first squared flange 42 which extends from the rounded surface 44 adjacent pane of glass 34, as well as a second squared flange 46 which extends from the rounded surface 44 adjacent second sheet 16 and wood veneer 32. The second glass stop 38 fits within notch 28 such that the interior side of stop 38 lies flush within notch 28 of internal wood block 24, lies flush with the end of second sheet 16, and lies flush with the end of wood veneer 32. The external end of second squared flange 46 terminates in flat and flush alignment with the exterior surface of wood veneer 32.

In a third embodiment, as shown in FIG. 4, the second glass stop 38 not only engages the glass 34 and internal wood block 24, but extends past the external surface of wood veneer 32. In this arrangement, the second glass stop 38 includes a cover section 48 that extends from rounded surface 44 and is that is positioned opposite the first squared flange 42. Cover section 48 first squared flange 42 extend from rounded surface 44 in approximate opposite directions. Cover section 48 extends a distance past the end of wood veneer 34. In this arrangement, the internal surface of cover section 48 is in flat and flush alignment and engagement with the exterior surface of wood veneer 32 and thereby covers the end of wood veneer 32 providing a clean and aesthetically pleasing appearance. The external surface of cover section 48 is arcuately shaped to also provide an aesthetically pleasing appearance. From the above discussion it will be appreciated that the fiberglass hybrid glass door having a wood veneer shown and described herein improves upon the state of the art.

Specifically, the fiberglass hybrid glass door having a wood veneer presented herein has an appealing aesthetic appearance of being a wood door, has the durability and provides the advantages of a fiberglass door, has a long useful life, is durable, requires less maintenance than a conventional wood door, and is more efficient than a conventional wood door among countless other improvements and advantages. Thus, one of ordinary skill in the art would easily recognize that all of the stated objectives have been accomplished.

It will be appreciated by those skilled in the art that other various modifications could be made to the device without parting from the spirit and scope of this invention. All such modifications and changes fall within the scope of the claims and are intended to be covered thereby.

What is claimed is:

1. A hybrid glass door, comprising:
a first fiberglass skin and a second fiberglass skin in parallel spaced relation;
an internal wood block disposed between the first and the second fiberglass skins;
a wood veneer attached to an outer surface of the second fiberglass skin;
a first glass stop connected to the first fiberglass skin and a second glass stop connected to the internal wood block; and
a glass pane secured between the first and the second glass stops.

2. The door of claim 1 wherein the internal wood block has a notch.

3. The door of claim 2 wherein the notch receives the second fiberglass skin such that the outer surface of the second fiberglass skin and the internal block dwell in a same plane.

4. The door of claim 2 wherein an end of the second fiberglass skin is aligned with a surface of the notch.

5. The door of claim 1 wherein an end of the second fiberglass skin aligns with an outer surface of the internal wood block.

6. The door of claim 3 wherein the second glass stop has a square corner with one side engaging the internal wood block and terminating short of the outer surface of the second fiberglass skin.

7. The door of claim 4 wherein the second glass stop fits within the notch such that a side of the second glass stop extends to lie flush with the wood veneer.

8. The door of claim 5 wherein the second glass stop engages the glass pane, the internal wood block, and the wood veneer.
